(19) United States
(12) Patent Application Publication
(10) Pub. No.: US 2024/0346421 A1
(43) Pub. Date: Oct. 17, 2024

(54) LANDSCAPE GRAPH FOR INFORMATION TECHNOLOGY OPERATIONS

(71) Applicant: SAP SE, Walldorf (DE)

(72) Inventors: Peter Eberlein, Malsch (DE); Volker Driesen, Heidelberg (DE)

(21) Appl. No.: 18/298,634

(22) Filed: Apr. 11, 2023

(51) Int. Cl. G06Q 10/0637

(52) U.S. Cl. CPC G06Q 10/0637

(57) ABSTRACT

In an implementation, a trigger generator module of a graph business object (GBO) factory creates trigger code. After replicating changes to an active business graph, the GBO factory: 1) for a GBO/graph business relation (GBR) create or delete action, executing trigger code of a specified trigger for a respective GBO/GBR type or 2) for a GBO/GBR update action of GBO/GBR attributes, executing trigger code of a specified trigger for a respective GBO/GBR type and attribute. Creating a temporary recommendation node (TRN) is created with the trigger code and using the GBO factory.

### BACKGROUND

Data objects that represent enterprise concepts can be modeled and used in enterprise applications. Data objects can be associated with other data objects. Accordingly, an association can model an inter-object relationship. Data objects can be persisted, for example, in a relational database. An association between two data objects can be stored, for example, as a foreign key relationship in the relational database.

When operating an information technology (IT) landscape, for a single large enterprise or as a software vendor offering Software as a Service (SaaS), information from a variety of distributed domains is required for an overview of software being deployed, versions, integrations, high availability, disaster setup, hardware utilization, and assignment of the instances to consumers. Currently available systems can provide data objects within an enterprise knowledge graph, but not a graph useable for IT landscape operations.

### SUMMARY

The present disclosure describes a landscape graph for information technology operations.

In an implementation, a computer-implemented method, comprises: creating, by a trigger generator module of a graph business object (GBO) factory, trigger code; using the GBO factory, after replicating changes to an active business graph: for a GBO/graph business relation (GBR) create or delete action, executing trigger code of a specified trigger for a respective GBO/GBR type; or for a GBO/GBR update action of GBO/GBR attributes, executing trigger code of a specified trigger for a respective GBO/GBR type and attribute; and creating, with the trigger code and using the GBO factory, a temporary recommendation node (TRN).

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, a graph can be automatically created from a set of data objects stored in one or more databases. Second, an application can take advantage of graph database features, including graph traversal and query flexibility. Third, a graph database can be extended to include relationships between data objects of separate applications. Fourth, a graph database can be automatically synchronized with a relational database in response to a change in one or more objects in the relational database. Fifth, an application developer can determine, on a semantic data object level, what relational database data is replicated to a graph database. Sixth, an application developer can interact with a graph object replicated from a corresponding data object using an interface that is similar to the corresponding data object.

Further, identified improvements to the subject matter described in this specification can be implemented to realize one or more of the following additional advantages. First, in the described system and methodology, customer-defined actions can be executed upon replication of changes to an active business graph. Second, the customer-defined actions can be specified as “constraints” or “checks” (for example consistency checks, and respective code to execute the consistency checks is generated by infrastructure, and providing a “low-code” experience for a developer). Third, the checks can be executed automatically upon changes using triggers, where the triggers and trigger code is generated from a high-level description. Fourth, results can be stored within the active business graph in temporary recommendation nodes that allow simple post-processing by providing immediate navigation and access to related nodes within the active business graph. Fifth, compared to other data storage composed of replicated data, the active business graph enables a combination of graph algorithms and custom code modules to be executed automatically during replication, which can modify content in the replicated storage, including the generation of temporary result nodes as anchors for further navigations within the active business graph. Sixth, the described system and methodology permits identified consistency problems on distributed data to be simply addressed.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a system for creating a graph database based on data objects, according to an implementation of the present disclosure.

FIG. 2 is an example of a data graph representing an example marketplace, according to an implementation of the present disclosure.

FIG. 3 is a block diagram illustrating an example of a system for creating a data graph from multiple relational databases, according to an implementation of the present disclosure.

FIG. 4 is a block diagram of an example of a system for using an object management user interface, according to an implementation of the present disclosure.

FIG. 5 is a block diagram of an example of a system for obtaining consent to link graph data objects, according to an implementation of the present disclosure.

FIG. 6 is a block diagram of an example of a system for synchronizing a data graph, according to an implementation of the present disclosure.

FIG. 7 is a block diagram of an example of a system for coordinating data object and graph object methods, according to an implementation of the present disclosure.

FIG. 8 is a block diagram of an example of a system for automatic creation and synchronization of graph database objects, according to an implementation of the present disclosure.

FIG. 9 is a flowchart illustrating an example of a computer-implemented method for automatic creation and synchronization of graph database objects, according to an implementation of the present disclosure.

FIG. 10 is a block diagram of a business graph framework and extensions for an active business graph implementation of the previously described approach(s), according to an implementation of the present disclosure.

FIG. 11 is a block diagram of a scenario for multi availability zone consistency check and its realization with triggers, according to an implementation of the present disclosure.

FIG. 12 is a block diagram of a scenario for multi availability zone consistency check creating a temporary recommendation node, according to an implementation of the present disclosure.

FIG. 13 is a flowchart illustrating an example of a computer-implemented method for providing a landscape graph for information technology operations, according to an implementation of the present disclosure.

FIG. 14 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes automatic creation and synchronization of graph database objects, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

In a modern interconnected world, integration between enterprise or other types of applications can be important for organizations. Relationships between datasets relevant in an enterprise can be varied and extensive, for example, and difficult to capture. An Enterprise Knowledge Graph (EKG) can be used for efficient management of enterprise data. However, integrating existing enterprise applications into an EKG can be challenging and resource-intensive. For instance, a manual update of an EKG after an update to a relational database or other object store may be required.

Alternatively, a systematic approach described herein can be used to automatically provide the benefits of an EKG (which can also be referred to as a data graph) to enterprise applications. A data graph can include two types of modeled objects: a Graph Data Object (GDO) and a Graph Data Relation (GDR). GDO and GDR instances can be persisted using a graph database.

A creation process can be automatically performed by a framework, for creating GDO and GDR instances from enterprise data objects (DO) that are stored, for example, in relational database(s). For instance, graph vertices can be derived from objects and entities in the relational database(s) and created as GDO instances in the data graph. Relationships can be determined from object associations and relational database foreign key relationships and can be stored as GDR instances in the data graph. Changes to DO instances can be automatically replicated by the framework to corresponding GDOs to keep DOs and GDOs in sync. Additionally, GDO and GDR methods can be used for enforcement of consistency constraints for individual GDO types.

The data graph can be a consistent representation of a set of objects created and stored by an application. Different applications (with separate databases) that each store DOs can be connected to a data graph that includes a superset of objects of different applications and databases. Additionally, the data graph can be extended by additional objects, which are not created from replication of DOs of an application, which represent relationships between applications. The additional GDOs can be linked, using GDRs, to GDOs that have been replicated from applications. Accordingly, otherwise disconnected graphs replicated from different applications can be interconnected in the data graph. Therefore, the data graph can enable access to enterprise data that is modeled as data objects that are stored in multiple relational databases spread across various systems. Data objects can be related to other data objects (even in remote applications) and the relations between objects can be queried in a more generic form, using the data graph, than with a relational model. Objects can be analyzed in a graph without explicitly formulating data object to data object relations on a relational database level. With a data graph, it can be sufficient that objects are in some relationship to each other, without specification of a concreate path. Accordingly, queries can be formulated without restriction to a concreate relational path.

Graph object creation and updates from data objects can be triggered on a semantic data object basis, rather than at a relational database level. Accordingly, data object developers can control, based on logic and semantic decisions appropriate for the object, what data is replicated to a data graph. Developers can opt-in or opt-out of some or all data graph replication, for example.

Applications that utilize a data graph can interface with the data graph using GDO and GDR methods, with at least some of the methods being similar to corresponding methods in the related data object. GDO and DO linkage can be bi-directional, in that a change to a GDO can be automatically reflected in a corresponding data object. Bi-directional linkage can allow application developers to freely navigate between graph objects or data objects, performing operations on either type, depending on what a developer decides is easier, more efficient, or more appropriate.

The framework can support advanced scenarios including connecting entities that originate from different systems and are therefore not connected by foreign keys within a database but are more loosely related by reference identifiers. Application developers can rely on the framework for establishing such connections, rather than performing custom development.

The framework processing can go beyond simple evaluation of relational database schema information. For example, process integration relationships can be evaluated when creating a graph, thereby linking systems and not just databases, based on semantic object identifiers (for example, purchase order number/sales order number).

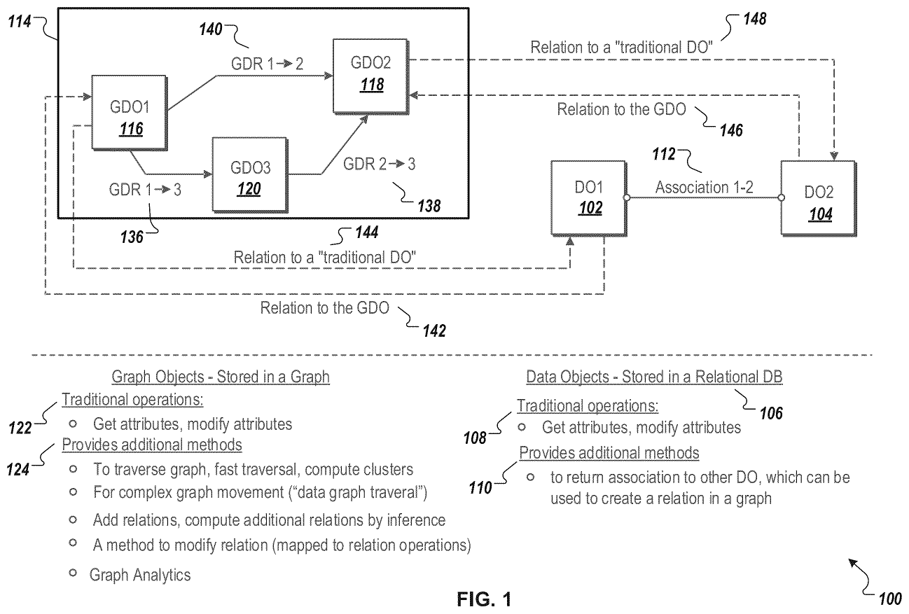

FIG. 1 is a block diagram illustrating an example of a system 100 for creating a graph database based on data objects, according to an implementation of the present disclosure. Data objects can represent instances of concepts in a processing system. Each data object can be instance of an object type, or class, for example. For instance, purchase order objects can represent instances of purchase orders in an enterprise system. The system 100 includes a first data object DO1 102 and a second data object DO2 104. As mentioned in a note 106, data for data objects can be stored in a relational database. As described in a note 108, data objects can provide operations (methods) to act on an object. Traditional operations can include retrieving and setting attributes of an object. Other operations can represent semantic operations on an object that may put an object into a different state, for example.

A note 110 indicates that data objects may provide other methods, such as methods to return or traverse associations to other data objects. For instance, the first data object DO1 102 can provide a method to return a reference to the second data object DO2 104, based on an association 112 between the two objects. In some implementations, the second data object DO2 104 can also provide a method, for returning a reference to the associated first data object DO1 102. The association 112 can be manifested as a foreign key relation in a relational database. Data object associations can be used to create a relation in a data graph between graph objects that correspond to data objects.

A data graph 114, for example, can include GDOs 116, 118, and 120 as graph vertices. The data graph 114 can be persisted in a graph database. The data graph 114 can be an EKG that can be used to model relations of different datasets in an enterprise, including objects or concepts that are related across systems or applications.

GDOs, as indicated by a note 122, can provide, like DOs, operations for retrieving and setting attributes. As described by a note section 124, GDOs and the data graph 114 can provide additional methods for graph traversal, beyond capabilities provided by DOs or a relational database. For instance, operations for graph traversal can be supported, including across an indefinite number of vertices or indirections in the data graph 114. The data graph 114 can enable traversing a longer path of relations in the graph more quickly, as compared to executing complex JOIN operations on a set of relational database tables. For example, a minimum spanning tree can be computed, and the data graph 114 can be analyzed for cycles and a shortest path between a given two vertices can be computed.

GDOs in the data graph 114 can be connected using GDRs. For example, a GDR 136 links the GDO 116 to the GDO 120, a GDR 138 links the GDO 120 to the GDO 118, and a GDR 140 links the GDO 116 to the GDO 118. A GDR can connect related GDOs. Relations can be added by linking two related GDOs, which can be less involved than, for example, establishing foreign key relationships in relational storage.

An automatic process can be performed to create GDOs and GDRs from data objects stored in relational database(s). For example, graph vertices can be derived from objects and entities in the relational database and created as GDOs in the data graph 114. For instance, the GDO 116 can be created from the first data object DO1 102 and the GDO 118 can be created from the second data object DO2 104. Associations 142 and 144 can link the first data object DO1 102 to the GDO 116 and the GDO 116 to the first data object DO1 102, respectively. Similarly, associations 146 and 148 can link the second data object DO2 104 to the GDO 118 and the GDO 118 to the second data object DO2 104, respectively. As described in more detail in following figures, bi-directional linking can enable keeping GDOs in sync with related DOs.

Relationships between GDOs can be determined from associations and foreign key relationships of corresponding data objects. Determined relationships can be created as GDRs in the data graph 114. For example, the GDR 140 can be created based on identification of the association 112. As described in more detail in following figures, GDOs can be created other than from an identification of a data object. For instance, the GDO 120 can be created as a concept that is known or is identified, that does not have a direct data object counterpart in a relational database. The GDO 120 can reflect application integration or relationship or a semantic concept from another system, for example. GDRs 136 and 138 can be created in response to determining that the GDO 120 is related to the GDO 116 and the GDO 118, respectively.

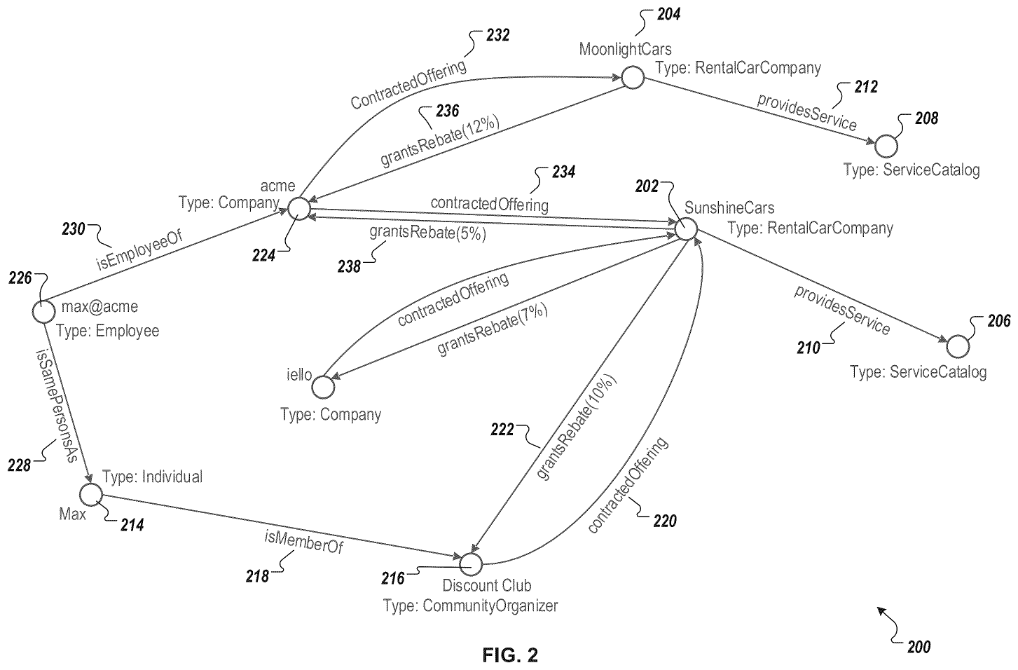

FIG. 2 is an example of a data graph 200 representing an example marketplace, according to an implementation of the present disclosure. The marketplace can be for the management of rental car offerings and discounts. The example data graph 200 illustrates how information can be retrieved from the data graph 200 by following various paths, or indirections in the data graph 200. For example, one, two, three, or even four or more paths could be traversed when processing a query. To similarly solve a same problem using just a relational database, complex queries 202 would need to be crafted, often including unions of queries for different numbers of indirections. Such queries would be cumbersome and time consuming to create and maintain. For instance, a relational query that may handle four indirections may not work if five indirections are actually needed.

In further detail about the data graph 200, a rental car company can offer its services to companies and individuals. For example, the data graph 200 includes a GDO 202 representing a Sunshine Cars rental car company and a GDO 204 representing a Moonlight Cars rental car company. Each rental car company can have a service offering, which can be represented by a service catalog. A respective service catalog can be represented on the data graph 200 as a GDO and then linked to a corresponding car rental company GDO. For instance, service catalog GDOs 206 and 208 are linked to the GDO 202 or the GDO 204, using a GDR 210 or a GDR 212, respectively.

A rental car company can offer discounts to consumers. Discounts can be the same for all users or can be user-specific, and can be offered directly to users or a user can obtain a discount based on a membership in a discount club or community organizer group. For instance, a user Max, an individual represented by a GDO 214, is a member of a discount club represented by a GDO 216, with the membership being reflected by an is-member-of GDR 218. The discount club can have a contracted offering (reflected by a GDR 220) with the Sunshine Cars rental car company 202, for example. The contracted offering can result in a granting of a rebate of, for example, ten percent (as reflected by a GDR 222). The user Max can receive the ten percent discount at Sunshine Cars, based on the membership in the discount club.

Max is an employee of an ACME company represented by a GDO 224. Max can participate in the marketplace either as a private user or as an employee of the ACME company. Max as a private user may have different contact or identifying information than Max as an ACME employee. For instance, a GDO 226 represents Max as an employee. A GDR 228 reflects that Max as an employee is the same person as the private user Max. A GDR 230 reflects the employee-employer relationship of Max with the ACME company. A company can have a contract with a rental car company. For instance, as reflected by contracted-offering GDRs 232 and 234 and granted-discount GDRs 236 and 238, ACME has a contracted offering with both the Moonlight Cars rental car company and the Sunshine Cars rental car company that can result in discounts of twelve or five percent, respectively.

A car rental application can use the data graph 200 to determine car rental offers and associated discounts for a user such as Max. For example, when Max wants to rent a car, all paths of the data graph 200 from Max to a GDO of type “RentalCarCompany” can be traversed, with each corresponding identified rental car company offering a service available for Max. Out of the paths from Max to a RentalCarCompany GDO, all paths that have a relation “contractedOffering” can be identified, which can lead to identification of paths that have relations of type “grantRebate.” A discount attribute of each “grantRebate” relation can be read to determine an available discount value. If two relations with a discount are passed in a same path the discount amounts can be added. Accordingly, traversal of the data graph 200 for Max can result in identification of offered services by Moonlight Cars with a discount of 12%, services of Sunshine Cars with a discount of 5% (from the ACME employer), and a 10% discount from the discount club. The application can thus show Max the offerings and the discounts that are applicable for Max, even if the offerings are facilitated through different organizations. The application can work unchanged, even as additional nodes (reflecting other discounts and companies) are added to the data graph 200.

The data graph 200 can be a standalone data structure that is not based on data objects. However, some or all of the entities and concepts reflected in the data graph 200 may originate from data objects that are used or provided by existing application(s) that use, for example, one or more relational databases. Existing data objects and data relationships can be leveraged, by automatic creation of the data graph 200 from existing data sources. An application can use the data graph 200, for advanced querying, as previously described, without requiring an abandonment of traditional applications that use an existing data object infrastructure or a manual effort to create the data graph 200 from scratch. Applications can be crafted to use one or both types of data bases, depending on application needs.

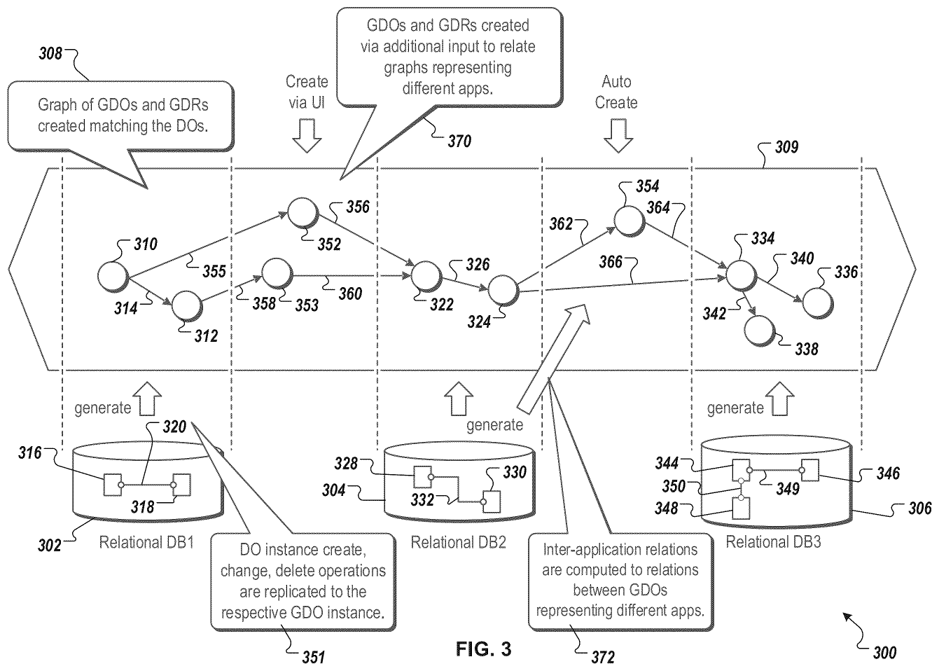

FIG. 3 is a block diagram illustrating an example of a system 300 for creating a data graph from multiple relational databases, according to an implementation of the present disclosure. Data for different enterprise processes, systems, or applications can be stored in different databases. For example, data of an application built from microservices can be stored in a database that is separate from databases of other applications or services. For example, the system 300 includes a relational database 302, a relational database 304, and a relational database 306, for three different applications/services.

Multiple disparate databases generally do not allow for efficient running of cross domain analysis across the different databases. Related data cannot be easily followed from one application to another. While data analysis on a superset of data of different databases can be answered from a replicated data store such as a data warehouse or data lake, such secondary data stores are generally optimized for data aggregation, not for traversal of paths between associated objects. As an improved solution, realtime cross-domain queries can be efficiently processed using a data graph. The data graph can be created from multiple data sources and extended over time to hold information normally held in separate databases.

As mentioned by a note 308, a data graph 309 including GDOs and GDRs can be created from the DOs and associations in the relational databases 302, 304, and 306. For example, a GDO 310, a GDO 312, and a GDR 314 have been created based on a DO 316, a DO 318, and an association 320 included in the relational database 302, respectively. As another example, a GDO 322, a GDO 324, and a GDR 326 have been created based on a DO 328, a DO 330, and an association 332 included in the relational database 304, respectively. As yet another example, a GDO 334, a GDO 336, a GDO 338, a GDR 340, and a GDR 342 have been created based on a DO 344, a DO 346, a DO 348, an association 349, and an association 350 included in the relational database 306, respectively. As indicated by a note 351 (and described in more detail in further paragraphs), DO instance create, change, and delete operations can be replicated to a respective GDO instance.

After replication of DOs to GDOs, the data graph 309 includes data of different applications in one graph. The data graph 309 can be a global graph spanning multiple graphs representing objects from different applications. The data graph 309 can include representations of the application graphs and can also include additional vertices and additional edges that describe relationships between objects in the different applications. The system 300 can therefore enable relating and connecting otherwise non-connected graphs replicated from the different applications.

For instance, the data graph 309 can be extended by additional objects not created as replication DOs. For example, GDOs 352, 353, and 354 can be created in the data graph, as GDOs that are not replicated from the relational databases 302, 304, or 306. Additional created GDOs can be related to GDOs replicated from applications using GDRs. For example: the GDO 352 can be connected to the GDO 310 using a GDR 355 and to the GDO 322 using a GDR 356; the GDO 353 can be connected to the GDO 312 using a GDR 358 and to the GDO 322 using a GDR 360; and the GDO 354 can be connected to the GDO 324 using a GDR 362 and to the GDO 334 using a GDR 364. In some implementations, GDOs created from different applications can be linked directly using a GDR. For instance, the GDO 324 is connected to the GDO 334 using a GDR 366. The GDO 324 may represent a purchase order object and the GDO may represent a sales order object, for example, and the GDR 366 may reflect a linkage between a purchase order number and a sales order number (that may be reflected on documents exchanged between parties that have “our number/your number” information).

Additional GDOs can represent events that are raised by one application and consumed by one or more receiving applications. The additional GDO can include event information, including event metadata, such as retention time, information indicating whether event communication is synchronous or asynchronous, etc. The additional GDO can be a node that other objects from applications can subsequently connect to, with additional connections to the node representing other applications now consuming the event.

As indicated by a note 370, in some implementations and for some objects, additional GDOs or GDRs can be created in response to additional input from a user. For instance, a maintenance user interface can be used to create graph objects that have not been automatically created from replication. The GDO 352 and the GDO 353 can be created from user input, for example.

As another example and as indicated by a note 372, inter-application relationships can be automatically determined and reflected as relationships between GDOs representing different applications. For example, application integration information (for example, integration scenarios) can be evaluated, to determine application to application relationships. The GDO 354 can be automatically identified from integration information, for example. The GDO 354 can represent an intermediary object that is passed between two applications during an integration, for example. For instance, if the GDO 324 represents a purchase order and the GDO 334 represents a sales order, as previously described, the GDO 354 can represent purchase order information that is sent using electronic data exchange. The GDO 354 can have a separate identifier that can be referenced from both a purchase order object and a sales order object.

In general, automatic identification of inter-application relationships can be performed in a rule-based manner, for example to identify external references that may exist or be associated with a given application. For instance, semantically linked cross-application identifiers, at a semantic data object level, can be identified, even when such identifiers are not linked or included at a foreign key/relational database level. For instance, a purchase order object in a first system may include a reference to a sales order number that represents a sales order object in a different second system, and an inter-application relationship can be identified automatically, even when the relational database system of the first system does not store a sales order table or a foreign key relating to sales orders.

A GDO that links disparate systems can represent a logical external system that is used by or referred to a given source application or system. A GDO linking systems can represent a remote application instance, and can have attributes such as a Uniform Resource Locator (URL) of the remote system. As another example, a GDO linking systems can represent communication endpoints or destinations that are used by connected systems.

The data graph 309, once populated with replication and other types of objects, can enable operations and queries on data spanning different applications. For example, an application configured to use the relational database 304 can submit a query to the data graph 309 for objects related to the data object 330. The data graph 309 can identify and provide, as related objects, the graph data object 324, the graph data object 334, and by association, the data object 344 in the relational database 306. The data graph 309 can be constructed more easily and with less impact on existing applications and databases, as compared to custom development in respective applications that may have to occur to reflect, in traditional systems, inter-application relationships, for example. Custom, in-application development may be time consuming and may not be reusable in other contexts.

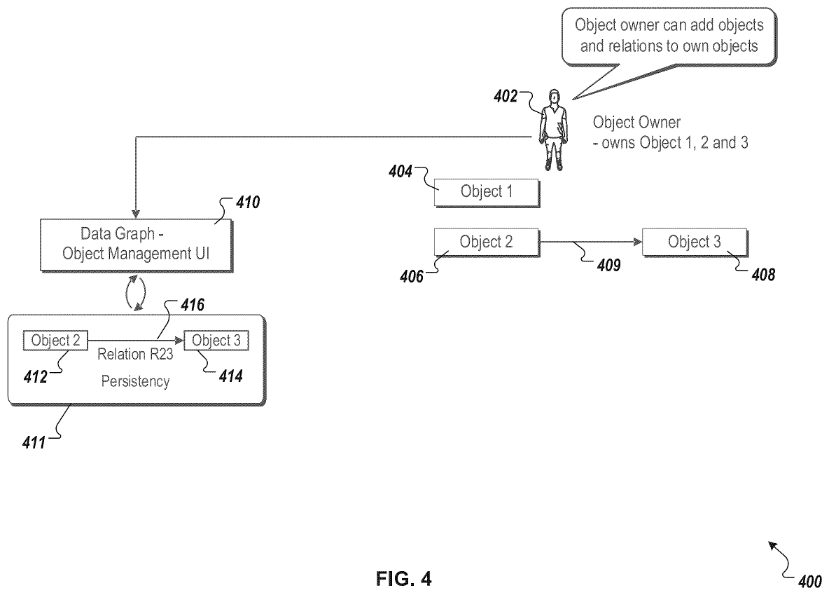

FIG. 4 is a block diagram of an example of a system 400 for using an object management user interface, according to an implementation of the present disclosure. Although data graph objects can be created automatically, as mentioned, from data objects, data graph objects can also be created manually by an object owner, or can be created or modified automatically but conditionally, based on data object owner consent.

An object (or object type) owner 402 (for example, a developer), can own a first data object 404, a second data object 406, and a third data object 408. The second data object 406 is linked to the third data object 408 using an association 409. The object owner 402 can use a data graph object management user interface 410 to create, in a data graph persistency 411, a GDO 412 corresponding to the second data object 406, a GDO 414 corresponding to the third data object 408, and a GDR 416 corresponding to the association 409. The object owner 402 can choose to create or not create a GDO for the first data object 404, for example.

As another example, the object owner 402 can use the object management user interface 410 to configure consent for data graph support for some or all of the data objects owned by the object owner 402. Data graph support can include providing (or restricting) consent for keeping data objects and corresponding data graph objects in sync, for example. Consent information can be stored in the data graph persistency 411. A data graph can be extended by additional attributes that can define creation and modification processes, regarding which data may be stored upon Create, Update, Delete (CUD) operations and which relations and attributes can be read by different business processes.

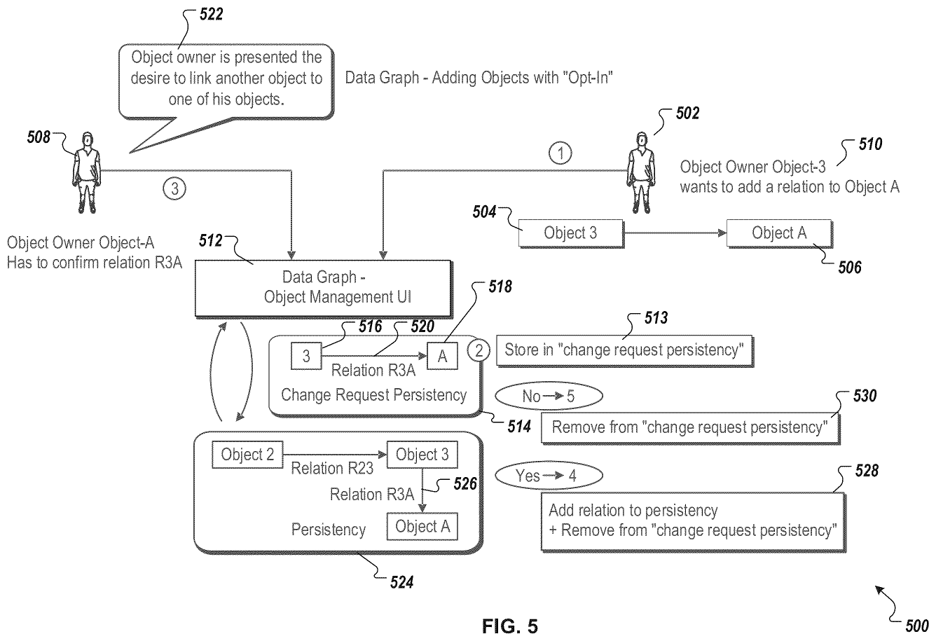

FIG. 5 is a block diagram of an example of a system 500 for obtaining consent to link graph data objects, according to an implementation of the present disclosure. A first object owner 502 owns a data object 504 that is related to a data object 506 owned by a second object owner 508. As indicated by a note 510, the first object owner 502 wants to add (or to have added), in a data graph, a GDR that connects GDOs corresponding to the data object 504 and the data object 506.

In a first stage (represented by a circled “one”), the first object owner 502 sends a request to a data graph object management user interface 512, for connecting GDOs corresponding to the data object 504 and the data object 506. As indicated by a note 513, the request can be stored, in a second stage, in a change request persistency 514, and can be for connecting a GDO 516 corresponding to the data object 504 with a GDO 518 corresponding to the data object 506, using a GDR 520. In a third stage and as illustrated in a note 522, the second object owner 508 is presented with an approval request for approving the request sent by the first object owner 502.

In a fourth stage that represents an approval from the second object owner 508, the requested link is stored in a data graph persistency 524 as a GDR 526. As indicated by a note 528, the request from the first object owner 502 is removed from the change request persistency after the GDR 526 is established in the data graph persistency 524. As indicated by a note 530, in a fifth stage that represents a rejection from the second object owner 508, the request from the first object owner 502 is removed from the change request persistency 514, in response to the rejection.

Accordingly, relations in a knowledge graph may depend on consent of an object provider/owner. Consent approval can provide a solution for a fact that not all relations should necessarily be allowed to be created (or desired by an application designer). Legal, policy, or privacy considerations (for example, as specified by General Data Protection Regulation (GDPR)) may result in consent configurations that prevent certain relationships or objects from being completely or fully replicated into or linked to other objects in a data graph.

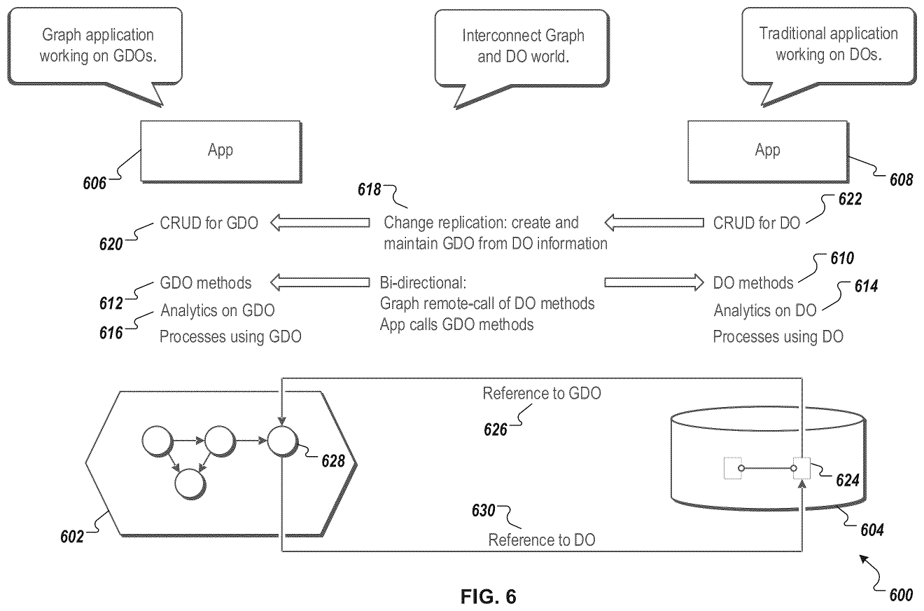

FIG. 6 is a block diagram of an example of a system 600 for synchronizing a data graph, according to an implementation of the present disclosure. After automatic creation of a data graph 602 from at least one relational database such as a relational database 604, the data graph 602 can include a mirror representation of data objects from the relational database(s). Accordingly, applications can be developed to use either the graph database 602 or the relational database 604, or switch between the graph database 602 and the relational database 604 according to application needs.

New or existing applications can be integrated into an EKG environment using the data graph 602. For example, a new graph application 606 can be configured to use the data graph 602. As another example, an existing traditional application 608 can continue to use the relational database 604 and can also be modified to use some features of the data graph 602.

Any suitable application can use the graph database 602 or the relational database 604. An application can use data object methods 610 or GDO/GDR methods 612, to act on data objects or graph objects, respectively. Modify operations by applications to the data graph 602 can be limited to a method layer that includes graph methods and respective GDO and GDR methods, to ensure consistency of the data graph 602. Additionally, applications can perform data object analytics 614 or graph object analytics 616.

The system 600 can be configured to keep the data graph 602 and the relational database 604 synchronized when either graph or data object instances are modified. Using a change replication framework 618, changes made to data object instances can be replicated to corresponding GDOs to keep the data objects and the GDOs synchronized. Otherwise, the data graph 602 and the relational database 604 could become unsynchronized. Create, Read, Update, and Delete (CRUD) operations 620 and 622 can be configured, in the graph and relational worlds, for synchronization, respectively. A data object and a corresponding GDO can be bi-directionally linked, to support synchronization. For example, a data object 624 can include a reference 626 to a corresponding GDO 628 and the GDO 628 can include a reference 630 to the data object 624.

Consistency operations can include performing two types of operations, including first operation(s) on the relational database 604 and second operation(s) on the graph database 602. Error handling can include handling a failure of either a first or second operation. For example, transactional support can be included, such as rolling back a first operation if a second operation fails. As another example, requests can be stored in an update queue, and if a particular update fails, an operator can be notified to examine the update in the update queue and resolve the failure.

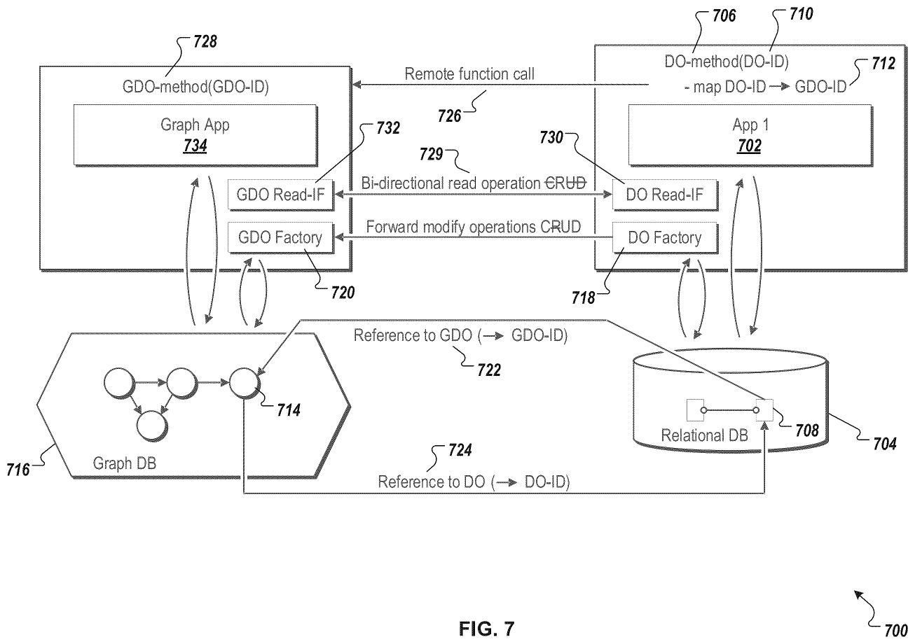

FIG. 7 is a block diagram of an example of a system 700 for coordinating data object and graph object methods, according to an implementation of the present disclosure. An application 702 that uses a relational database 704 can, during processing, invoke a method 706 on a data object 708 (for example, having an object identifier 710). The object identifier 710 may have been mapped to a GDO identifier 712 of a corresponding GDO 714 stored in a graph database 716, for example. A DO factory 718 may have provided the object identifier 710 to a GDO factory 720, for example. The GDO factory 720, in turn, can provide the GDO identifier 712 to the DO factory 718. Accordingly, the data object 708 can have a reference 722 to the GDO 714 and the GDO 714 can have a reference 724 to the data object 708.

If the method 706 results in a modification (for example, an update to or a deletion of) the data object 708, the DO factory 718 can forward modify operation requests to the GDO factory 720, so that the GDO factory 720 can modify the corresponding GDO 714. Forwarding the modify operation request can include using a remote function call 726 to invoke a GDO method 728 that corresponds to the method 706.

Bi-directional read operations 729 can be supported, using a data object read interface 730 and a GDO read interface 732, that enable the application 702 to read graph object information and a graph application 734 to read data object information, respectively. In some implementations, the GDO read interface 732 uses optimized graph operations and algorithms to perform operations directly on a graph. Various graph query languages can be supported. Graph vertices and edges can have identifiers that map to corresponding GDO or GDR instances, respectively. A graph read operation that results in a set of vertices and edges can be mapped to a set of GDO and GDR instances.

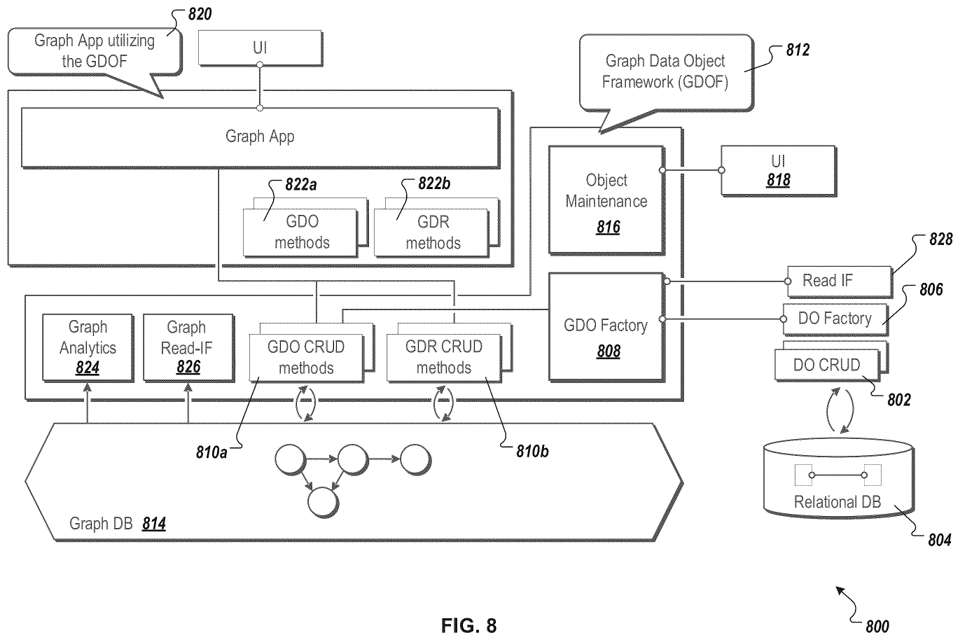

FIG. 8 is a block diagram of an example of a system 800 for automatic creation and synchronization of graph database objects, according to an implementation of the present disclosure. Data object CRUD operations 802 on data objects in a relational database 804 can result in a DO factory 806 triggering a GDO factory 808 to invoke corresponding GDO and GDR CRUD application method(s) 810a or 810b, respectively, in a GDO framework 812 to make corresponding changes to corresponding GDOs in a graph database 814.

During replication, the GDO factory 808 can create a related GDO for an existing DO. The DO factory 806 can pass a DO instance to the GDO factory 808. The GDO factory 808 can read a DO identifier, a DO type, DO attributes, and DO associations of the DO instance. The GDO factory 808 can create a GDO instance as a vertex of a graph with a new GDO identifier for the instance, add a DO identifier property to the GDO instance that links the GDO instance to the DO instance, add other properties to the GDO instance based on attributes read from the DO instance, and send an update request to the DO factory 802 to add an attribute to the DO instance with the value of the GDO identifier, to link the DO instance to the GDO instance.

The GDO factory 808 can iterate through the associations of the DO instance to establish relationships for the GDO instance. For each association, the GDO factory 808 can identify, using the association, a related DO instance related to the original DO instance, extract an identifier of the related DO instance, determine whether a GDO instance exists that is linked to the related DO instance, create a related GDO instance for the related DO instance if no GDO instance had already been created for the related DO instance, create a GDR relating the related GDO instance to the GDO mapped to the original DO instance, and add attributes to the GDR based on attributes of the DO association.

The GDO framework 808 includes an object maintenance component 816 that can be used for creating non-replication GDOs (for example, using a provided user interface 818). A GDO type and GDO property values can be provided to the GDO factory 808, for creation of a new GDO. The GDO factory 808 can create a new GDO instance as a vertex of the graph, establish a GDO identifier for the new GDO instance, and add properties to the new GDO instance based on the provided property values.

A graph application 820 can include GDO and GDR method calls 822a or 822b, respectively, that, when called, result in execution of GDO and GDR CRUD application methods 810a or 810b, respectively. The graph application 820 can also invoke GDR method(s) or graph-level methods applicable to the graph itself. An overall set of GDO, GDR, and graph methods provided by the GDO framework 812 can be an API for the graph application 820 that when used can result in consistency both within the graph database 814 and the consistency of the graph database 814 with the relational database 804 (and other associated databases). The API provided by the GDO framework 812 can ensure other types of consistency, such as ensuring that requested operations follow a state-model and only allow defined state transitions.

The graph application 820 can use a graph analytics engine 824 or a graph read interface 826 for graph read operations that execute path traversal, path analytics and other read-path algorithms. Example queries can include: querying whether two GDO instances are related, either directly or from a path that has intermediary object(s); querying for a list of GDOs that are related to an input GDO, with an optional depth constraint; querying for GDOs or GDRs by name or identifier; or other types of queries. A read-operation on a GDO instance can retrieve a corresponding DO identifier and read data of the related DO. Similarly, a read operation on a DO performed using a DO read interface 828 can retrieve a related GDO instance identifier and read data of the related GDO.

If a DO instance is deleted, the GDO-factory 808 can be invoked to make the graph database 814 consistent with the DO instance deletion. Simple deletion of a related GDO instance can lead to an inconsistent graph, as there may be edges going to or from the GDO instance. Accordingly, to consistently delete a related GDO instance, the GDO factory can first delete all edges going to and from the GDO instance. Other approaches can be used. For instance, the GDO framework 812 can respond with an error message to the DO factory to a deletion request if a related GDO instance to be deleted is connected to other items in the graph.

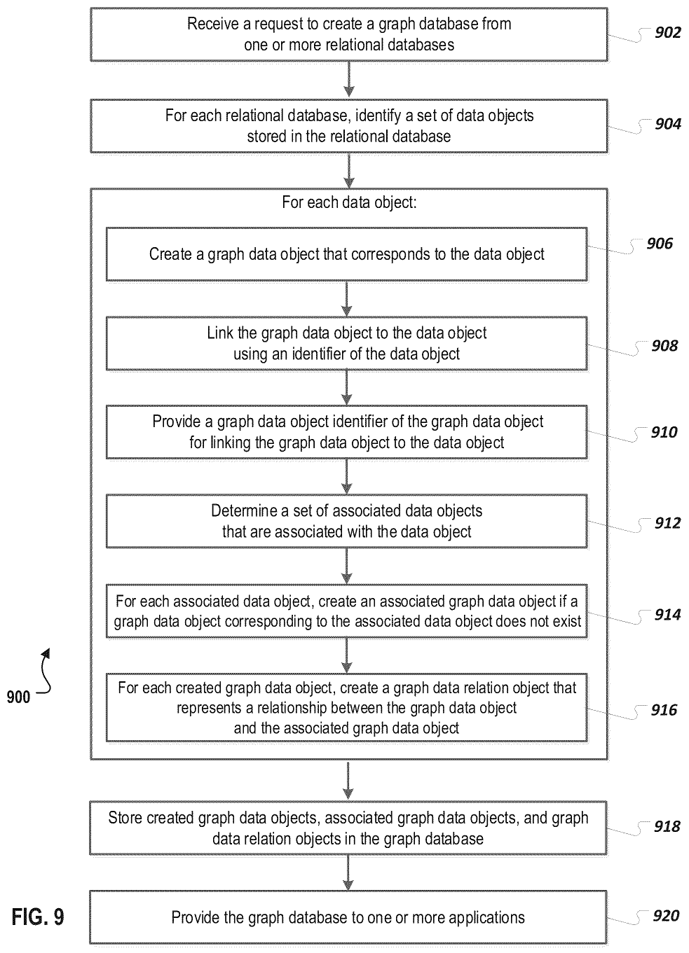

FIG. 9 is a flowchart illustrating an example of a computer-implemented method 900 for automatic creation and synchronization of graph database objects, according to an implementation of the present disclosure. For clarity of presentation, the description that follows generally describes method 900 in the context of the other figures in this description. However, it will be understood that method 900 can be performed, for example, by any system, environment, software, and hardware, or a combination of systems, environments, software, and hardware, as appropriate. In some implementations, various steps of method 900 can be run in parallel, in combination, in loops, or in any order.

At 902, a request is received to create a graph database from one or more relational databases. From 902, method 900 proceeds to 904.

At 904, for each relational database, a set of data objects stored in the relational database is identified. For each identified data object stored in the relational database, a set of processing steps is performed. From 904, method 900 proceeds to 906.

At 906, a graph data object is created that corresponds to the data object. From 906, method 900 proceeds to 908.

At 908, the graph data object is linked to the data object using an identifier of the data object. Additionally, one or more properties can be added to the graph data object based on a set of attributes read from the data object. From 908, method 900 proceeds to 910.

At 910, a graph data object identifier of the graph data object is provided for linking the graph data object to the data object. The graph data object identifier can be provided to a data object factory that maintains data objects in the relational database. From 910, method 900 proceeds to 912.

At 912, a set of zero or more associated data objects that are associated with the data object is determined. From 912, method 900 proceeds to 914.

At 914, if at least one associated data object has been determined, for each associated data object, an associated graph data object is created if a graph data object corresponding to the associated data object does not exist. A graph data object may have already been created due to a previously processed association, for example. From 914, method 900 proceeds to 916.

At 916, for each created graph data object, a graph data relation object is created that represents a relationship between the graph data object and the associated graph data object. From 916, method 900 proceeds to 918.

At 918, created graph data objects, associated graph data objects, and graph data relation objects are stored in the graph database. From 918, method 900 proceeds to 920.

At 920, the graph database is provided to one or more applications. The one or more applications can query the graph database. After 920, method 900 stops.

After the graph database has been created, a change to a first data object in a first relational database can be determined. A first graph data object corresponding to the first data object can be identified and the first graph data object can be updated based on the change in the first data object. As another example, a change to a first graph data object can be detected in the graph database, for example based on an update from an application. A first data object corresponding to the first graph data object can be identified and information for the first change can be provided, for example to the data object factory, for updating of the first data object.

In some implementations, the one or more relational databases include a first database for a first application and a second database for a second application. One or more inter-application relationships between the first application and the second application can be identified that are not represented as a foreign key in the first database or the second database. For each inter-application relationship, a first graph data object created from the first database can be linked with a second graph data object created from the second database, using either a graph data relation object or an intermediary graph data object. Providing the graph database to one or more applications can include enabling the one or more applications to query for inter-application relationships.

The following description describes an improvement of the previously described approach(s) of FIGS. 1-9 to provide a business graph framework and extensions for an active business graph implementation. Although the following is described in the context of a business-type implementation, the described improvement can be used for other purposes, for example software or other data deployment, data set relationship management, and application integration.

When operating an information technology (IT) landscape, for a single large enterprise or as a software vendor offering Software as a Service (SaaS), information from a variety of distributed domains is required for an overview of software being deployed, versions, integrations, high availability, disaster setup, hardware utilization, and assignment of the instances to consumers. Currently available systems can provide data objects (for example, a business object) within an EKG/data graph (or “business graph”), but not a business graph useable for IT landscape operations.

Described is a system to process near-real-time consistency checks on distributed data with processes to manage check findings and embedding recommendations in the findings. The business graph consists of data replicated from distributed systems and is extended by a check framework as an active business graph, which can generate triggers and trigger coding from constraint definitions and execute the triggers on active business graph changes during replication. Results can be stored within the active business graph in temporary recommendation nodes that allows simple post-processing by providing immediate navigation and access to related nodes within the active business graph. The active business graph can be used to create a landscape graph, which can be used for IT landscape operations.

Data in a landscape graph will be primarily replicated from several management systems: 1) “horizontal integration” of data, including information for the same domain from different application types being used (for example, cloud-computing-based (such as CLOUD FOUNDRY) and ABAP-based), deployed to different hyperscalers and operations data exposed and 2) “vertical integration” of data, including information from hardware, virtual machines/containers, application servers, applications, configuration, cross-application integration, and assignment of an instance to a consumer.

Data being replicated from management systems can have differing persistency structures (for example, not necessarily stored in a relational database). So, in the landscape graph, a uniform graph representation of data is provided, which allows for uniform access to all required data in a single service. The uniform graph representation also allows for fast cross-domain data traversal, which would not be possible with a distributed set of services with differing application programming interfaces (APIs) and data formats.

The described landscape graph offers unique capabilities for cross-domain data analysis. For example: 1) checking data consistency since cross-domain data was originally managed in a distributed set of systems and 2) identifying (near) real-time data changes, especially changes of data sets part of a consistency check, of data sets of different origins. This can enable near-real time consistency check loops.

The described system and methodology can include one or more advantages. First, in the described system and methodology, customer-defined actions can be executed upon replication of changes to an active business graph. Second, the customer-defined actions can be specified as “constraints” or “checks” (for example consistency checks, and respective code to execute the consistency checks is generated by infrastructure, and providing a “low-code” experience for a developer). Third, the checks can be executed automatically upon changes using triggers, where the triggers and trigger code is generated from a high-level description. Fourth, results can be stored within the active business graph in temporary recommendation nodes that allow simple post-processing by providing immediate navigation and access to related nodes within the active business graph. Fifth, compared to other data storage composed of replicated data, the active business graph enables a combination of graph algorithms and custom code modules to be executed automatically during replication, which can modify content in the replicated storage, including the generation of temporary result nodes as anchors for further navigations within the active business graph. Sixth, the described system and methodology permits identified consistency problems on distributed data to be simply addressed.

The described system and methodology provides a landscape graph service (LGS), storing information from a landscape directory and product model data. The idea is to enrich data with additional information on managed tenant connections (for example vendor or customer), service meshes, infrastructure (for example, infrastructure as a service (IaaS), data centers (DCs), hosts, and storage), and federate with graphs representing an IT landscape (that is, a digital twin of a customer landscape). The LGS service provides graph query access to the active business graph as well as an option to run graph algorithms and machine learning (such as, graph embeddings) on data, which could be used as input for graphical landscape visualization, dependency analysis, and similarity and deviation detection. In some implementations, the LGS is updateable, as previously described. The LGS service can also act as a source and raise events on landscape changes and provide an environment for consistency checks and processes to identify/resolve inconsistencies.

The active business graph is most valuable if many domains contribute. The content and provided capabilities need to be co-created by organizations owning different data domains and systems holding original data. To grow an active business graph in scope, a domain owner can use a business graph service, adding custom data and linking to present domains.

The LGS can offer superior capabilities for graph traversal and can export data as objects for use with data science graph libraries. In some implementations, the LGS can be used to form machine learning algorithms on the graph, such as clustering and similarity analysis (for example, using graph embeddings.

The described system and methodology is generally related to distributed software (for example, business software), with solutions composed of a number of applications with separate databases (for example, enterprise resource planning (ERP), customer relationship management (CRM), supply chain management, and sustainability management). Also included are technical applications used to operate the distributed software (that is, to offer them “as a service”).

Available systems allow creating a graph representation (that is, a business graph) out of data replicated from applications (for example, business applications). The graph representation allows cross-application data traversal and graph analytics based on the replicated data. The graph representation also allows creating custom applications on top of the graph representation. The business graph allowed for creation of additional nodes (that is, beyond nodes being created from replicated data).

Having one central representation of data, which is originally distributed, allows for evaluating a superset of data in context (for example, consistency checks). However, there is a need for reactive applications, which identifies changes in a central data representation and acts upon the identified changes. A central representation can allow for complex correlations of distributed data and define (for example, actions if a relation between two data records changes or is newly created, which are originally stored in distributed databases).

Use cases are, for example, related to data consistency. Constraints may be defined on distributed data, and a constraint violation can be found in an automatic and timely manner and actions can be defined to operate on an identified constraint violation.

Described are “active” components of business graph to generate an active business graph. The described system and methodology allows development of applications which extend what had been possible with a traditional business graph (or graphs related to a data warehouse cloud or enterprise knowledge graph). The active components are required to implement more the previously mentioned landscape graph. In come implementations, active components can include: 1) mechanisms for data comparison on attributes with weak associations across systems (having distributed databases); 2) creation of “triggers” on the business graph elements (that is, nodes and relations) to enable immediate actions upon changes to the graph content; and storing recommendations in temporary recommendation nodes that have additional qualities to enable simple browsing of collections of the temporary information, put them into context, enable navigation to other directly or indirectly related nodes, and management of temporary information status and timely deletion.

A generic problem description is related to usages of an active business graph, but especially for the Landscape Graph. The described system and methodology can provide consistency checks, violation detection, and enforcement on weakly associated data with complex relations.

If a record in table T1 is related to a record in table T2 and there is a foreign key relationship between these tables (potentially using additional tables for the join), constraints can be identified within this DB with some queries. For distributed data stored in different databases and potentially having different storage models (for example, non-relational), checking constraints or consistency rules is complex. The task becomes more complex, if the data records are not directly related, but using relations to intermediary nodes—potentially long chains of related nodes
or a manifold of potential relations and intermediary nodes. Even more complex is identifying a consistency violation between two attributes, especially if one or both attributes are aggregates or derived values of original data sets. These type of relations are called weakly associated data—data sets being related by auto-generated relations, relations crossing one more many intermediary nodes, and considering a manifold of potential relation types. In such cases, the aggregates and derived values have to be computed to detect a consistency violation. However, in typical relational data models and object models, comparing related data sets on different hierarchy levels requires many joins and can lead to long runtimes.

The described system and methodology can also provide consistency enforcement on distributed, weakly associated data. Consistency checks on weakly distributed data are enforced by finding consistency violations in “near real-time” and then triggering actions to either react manually or automatically. The triggered actions can then lead to eventual consistency. For this disclosure, the focus is on distributed data—data of different sources. However, constraints on data of one system can also be related in such complex, weakly associated ways—such that it can make sense to also apply the described system and methodology.

When a consistency violation is found, and data is to be changed (or “cleansed”), one approach is to modify the affected data centrally and replicate back for consistent state also for the distributed data. Another approach is to suggest new values and trigger a workflow for a user (for example, a human or automated software) to act upon. For such mechanisms, the recommendation needs to be persisted. It may also be required to trigger a data change process on the distributed system (for example, if the data record is not exposed with a modify-enabled API). The recommendation can be data with complex structures and linked to nodes in the active business graph. Storing the recommendations in another system can create an integration problem, so a recommended solution is to store the recommendations in the active business graph itself.

Data is not static, even master data changes. In some implementations, two types of changes to distributed data are envisioned: 1) changes to relations or new relations between data sets and 2) changes to attribute values. The question is how to identify that a re-check for consistency is necessary, since data sets or relations changed, followed by how to establish a fast (near real time) identification of consistency violation and a notification of users about this change or correct it automatically.

With respect to real-time deviations of a data set from a reference set, for some scenarios it is interesting to not only be aware of attribute value changes, but also to changes to data structure and data relations. For example, if one specifies a “reference data set with relations,” the question is whether deviations of the data being created or modified from the reference can be found. This is important to identify if a planned IT landscape deviates from a landscape blueprint specified for the software solution being deployed.

Note that the described system and methodology is not a database trigger or a trigger on a graph database. The trigger is abstract to the database and in an abstract layer.

At a high-level, traditional business graphs are extended by active components to enable automated actions in the active business graph. In some implementations, the extensions can include: 1) mechanisms for data comparison on attributes at nodes with weak associations across systems (having distributed databases); 2) triggers on business graph elements (for example, nodes and relations) to enable immediate actions upon changes to the business graph content; 3) temporary recommendation nodes (TRN) are provided additional qualities to make it easy to find temporary recommendations, manage their status, and enable timely deletion; and 4) consistency checks and an additional module are provided to compute triggers from a consistency definition.

Following the extensions, the upgraded system and methodology would include: 1) a business graph created out of replicated data from attached systems; 2) near-real-time consistency-checks across nodes and edges; 3) consistency checks being executed by triggers; 4) the triggers being computed out of a consistency definition; 5) the consistency checks modifying attributes in the business graph and triggering back-replication; or 6) creating temporary recommendation nodes.

Consistency checks are enabled on a central representation (graph) of data being replicated from distributed systems. The consistency checks can access attributes in two (or more) nodes, connected using one edge or a set of edges and nodes. For the consistency checks, a function can be provided to compute a result value (for example, TRUE/FALSE) of the read attribute values. Consistency check definition can be used to compute a set of triggers to observe consistency violations in near real-time.

In some implementations, the consistency violation check can: 1) invoke custom code to capture values to be used to create TRNs using a Graph Business Object (GBO) factory (for example, a previously described GDO factory) (allowing for a manual reconciliation or reconciliation via an external process); and 2) change an attribute to automatically resolve inconsistency and initiate a back-sync of the value using the business graph functionality.

A consistency check definition specifies: 1) (one) GBO type (for example, a GDO) 1 having attr1 (or attr11, attr12 . . . )+; 2) (one) GBO type 2 having attr2 (or attr2l, attr22 . . . )+; 3) a path between the specified GBO types: a) (one or many) Graph Business Relation (GBR)(for example, a GDR) types enabling defining a path relating these GBOs and b) including hops over additional GBOs of (one or many) GBO types; 4) a function computing a result value (e.g., true/false) from input (attr1, attr2) (or attr11, attr12, . . . , attr21, attr22, . . . ); and 5) (one or many) GBO types (TRNs, see below) created as temporary recommendation nodes and (one or many) GBR types used to relate these nodes.

The trigger generator will read the consistency check definition and: 1) create one “attribute update trigger” for each specified GBO type and defined attribute; 2) create one “create GBR trigger” for each specified GBR type of the “path”; 3) (optional) create one “create GBO trigger” for each specified GBO type of the “path,” if GBRs can be created with “dangling GBOs” and a GBO can be the last element to be created to close a “path”; and 4) the trigger code being derived from the specified check function, the definition of the attributes to read and the GBRs and GBOs part of the “path.”

With respect to data comparison on attributes with ‘weak associations,’ business graph capabilities implicitly provide this functionality: GBOs and GBRs can be read, graphs can be traversed, values can be read, relations could even be created by “inference” dynamically to run a data comparison if needed (and be deleted afterwards).

Examples can include: 1) date+timestamp fields when relations apply to ranges only; 2) relating attributes of substructures of two objects requiring cross object and in-object traversal; the relation is “easy in a graph”, but complex in relational store (many joins, header-item relations, foreign key relations etc.); and 3) regarding the scenario, navigate from a runtime to a datacenter, these can be very different relations to follow for different runtimes (for example, docker container to datacenter compared to a virtual machine to a datacenter this runs in.

With respect to triggers, “triggers” are enabled in the business graph. Triggers can be defined for nodes (GBOs) and edges (GBRs) and are executed when a specified change occurs. Triggers are enabled using the business graph Framework to make it independent of the capabilities of an underlying graph database and therefore portable across a variety of technology solutions.

Data replication (that is, the GBO-factory module) from the associated systems to the Business Graph identifies, that a trigger is defined for the node (or relation) being created, modified or deleted. Then, the trigger code is executed.

In some implementations, a trigger can be defined for a certain “GBO type”. A trigger can also be defined for a certain “GBR type”. The trigger can be specified, when to act: 1) upon creation of a new GBO or GBR instance and 2) upon deletion of a GBO or GBR instance.

Data modification using the GBO and GBR Update methods: an attribute “update trigger” can be defined for a certain “GBO type attribute” or “GBR type attribute”—act only for an “update” of an attribute value of an instance of this GBO type or GBR type.

Higher level actions which can be specified for the GBO-factory module to execute: 1) GBR changes (create, update, delete) limited to GBRs relating GBO of type1 and GBO of type2 and 2) this enables evaluating a constraint on now-related attributes, which had not been related before. As an example, scenarios like this can be created then by the developers using the above: 1) “updates of attribute 1 of GBO type1” or “update of attribute 2 of GBO type2”, when the modified instance of GBO type 1 is related to the modified instance of GBO type 2 by GBR of type3 and 2) this can be done by implementing two triggers (one on GBO type1 and one on GBO type2).

With respect to TRNs, TRNs are special variants of a GBO. A TRN has additional attributes: 1) type “temporary”: instances of this type can be retrieved from the Business Graph by querying for GBO instances of this type; 2) created at: stores the date and time when the instance has been created; 3) status: a status of the node—set by the developer using the TRN; 4) Deletion-condition: a condition (e.g., reading data from related GBO), when the TRN instance is automatically deleted; 4) retention time: a period of time, the TRN instance is automatically deleted, when the time since instance create exceeds the retention time; 5) archiving: The TRN instance values, and the relation information is written to a file.

In some implementations, the TRN can have in addition developer defined attributes and relations like a standard GBO. In some implementations, a TRN can be created from a trigger run, or from a analysis report, the framework can update fields automatically (like “created at”), the trigger or analysis report can update fields as well, especially developer defined fields.

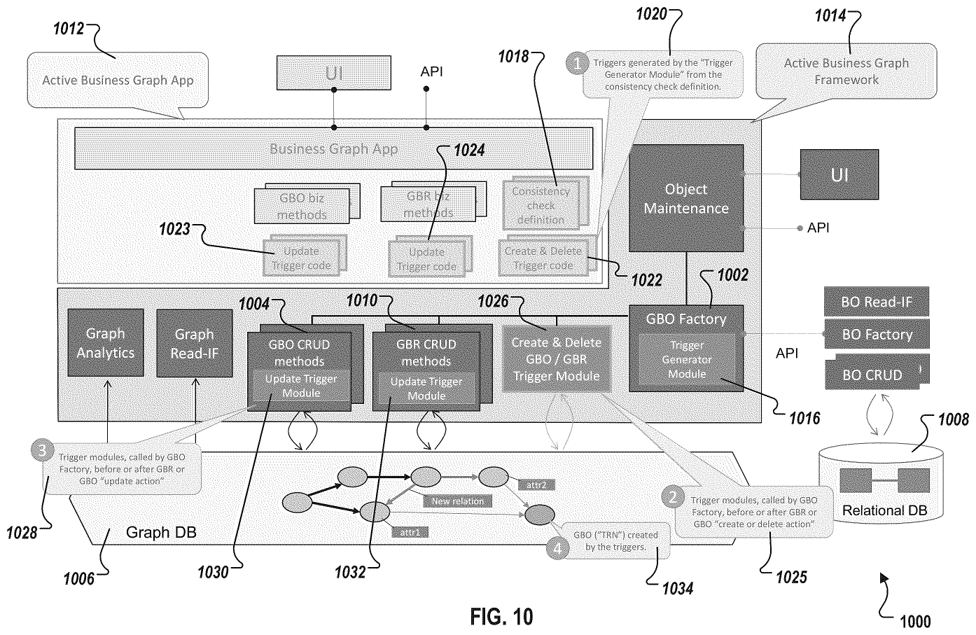

Turning to FIG. 10, FIG. 10 is a block diagram 1000 of a business graph framework and extensions for an active business graph implementation of the previously described approach(s), according to an implementation of the present disclosure.

A summary of the described approach of FIGS. 1-9 includes that:

GBO factory 1002 creates a GBO (for example, a GDO) instance using the CRUD methods 1004 of the GBO, and this way writes the GBO instance into the graph DB 1006 storage. GBO factory 1002 also passes an identification (ID) of the initial BO (for example, a DO) to the GBO create methods (that is, GBO CRUD methods 1004), so the GBO instance can have a relation to the BO instance in the relational database 1008 (if provided). The GBO factory 1002 can also create GBRs (for example, GDRs) using the CRUD methods 1010 of the GBR and in this way can relates two GBO instances in the graph DB 1006 storage.

The Business graph application 1012 provides content for the business graph framework 1014. The active business graph application 1012 can also run the GBO and GBR methods (1004 and 1010) and has read-write access to the graph DB 1006. The business graph application is configured to execute application code to operate on an active business graph by read operations executing path traversal, path analytics, and other read-path algorithms.

Extensions of the approach of FIGS. 1-9 include one or more new/modified components as illustrated in FIG. 10.

A trigger generator module 1016 is added as part of the GBO factory 1002, and can read consistency check definitions 1018 by the active business graph application 1012. As shown at (1) 1020, the trigger generator module 1016 can also create and delete trigger code 1022 “GBO and GBR create and delete” and update trigger code “GBO and GBR update” (1023 and 1024, respectively).

The GBO factory 1002, upon replicating changes to an “Active Business Graph”, can (2) 1025 create and delete GBOs or GBRs 1026, where a check is performed if a trigger is specified for the respective GBO or GBR type, and if yes, the respective trigger code is executed (as specified, “before” or “after” the respective action). At (3) 1028 for update of attributes in GBOs or GBRs (1030 or 1032, respectively), a check is performed if a trigger is specified for the respective GBO or GBR type and attribute, and if yes, the respective trigger code is executed (as specified, “before” or “after” the respective action). At (4) 1034, the trigger can create a GBO (a “TRN”) related, for example, to GBO instances being modified during the trigger execution.

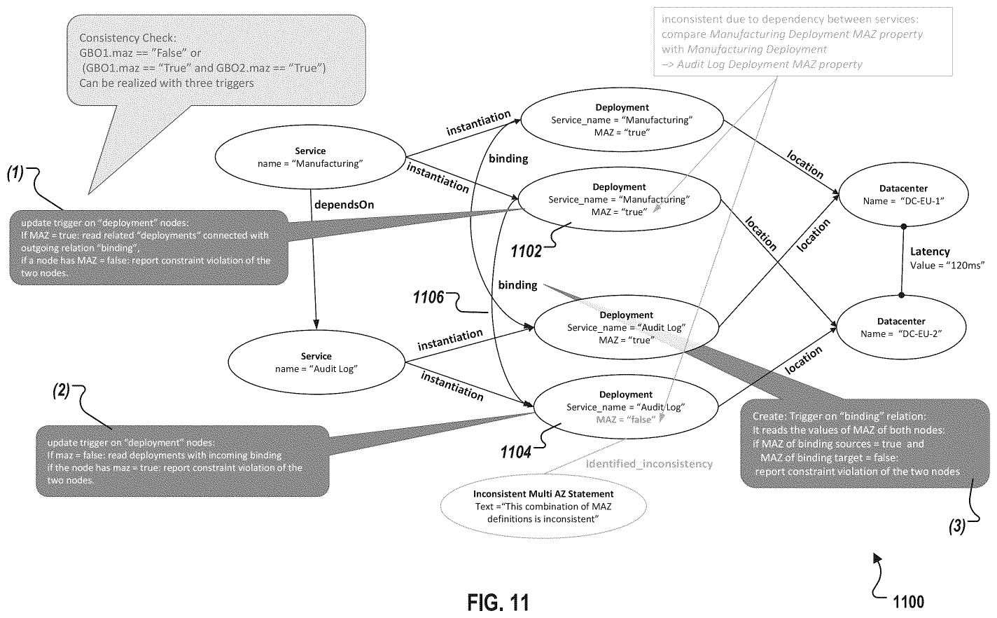

FIG. 11 is a block diagram 200 of a scenario for multi availability zone consistency check and its realization with triggers, according to an implementation of the present disclosure.

The following scenario description relates to a landscape graph: constraint, for example: consistency of “Multi AZ Support” Attributes in Service Meshes.

In FIG. 11, and at a high-level, a service S1 can use other services S2 . . . Sn. For each service deployment, the quality “Multi Availability Zone Support” (MAZ) is specified. But if a service S1 uses a service S2, the deployment can only have MAZ=true, if both service deployments (S1 and S2) have MAZ=true. If S1 uses a service S3, and the used deployment of S3 has MAZ=false, the deployment of S1 cannot have MAZ=true. Thus, a constraint should be defined to verify, if the MAZ values of related deployments are consistent.

If a deployment is modified and now the MAZ support is available (or no longer available), the value of MAZ of a single deployment is changed, thus the constraint needs to be re-evaluated if the values of MAZ are correctly set for the mesh of services considering also used service deployments. Similarly, if a service deployment is configured to have a binding to a new service deployment, the constraint needs to be also checked for this new dependency.

Ideally, the constraint is checked automatically upon changes to the dependencies and changes to the properties. This can be established in this case using three triggers: two node triggers and one relation trigger.

The node trigger: 1) is specified as an “after update” trigger, acting upon update of property of the node (in this case the property MAZ): a) If MAZ=true of this node and the value of MAZ of related “deployment”-nodes connected with outgoing “binding” relation=false or 2) if MAZ=false of this node and the value of MAZ of related “deployment”-nodes connected with incoming “binding” relation=true then, report a constraint violation of the two nodes, specifying the node ids and relation id.

The relation trigger: is specified, if a relation of type “binding” is created between two nodes or changed to relate to other nodes and the nodes have type “deployment” and the trigger acts “after create” (thus can access the content of the nodes part of the relation). The trigger code reads the values of MAZ of both “deployment”-nodes (source and target): if MAZ of binding sources=true and MAZ of binding target=false: report a constraint violation of the two nodes, specifying the node ids and relation id.

The described improvement of the previously described approach(s) of FIGS. 1-9 is used to implement an active business graph to solve this task. First, data of the required information providers (for example, landscape directory and configuration management database (CMDB)) is replicated into the Business Graph. A CMDB is a DB where organizations store information (for example, data about their systems and landscapes, hardware, software, configuration of the systems, and relations between these entities), and is typically used to keep an overview of what has been performed in a landscape and to enable root-cause analysis, if something goes wrong (for example, to determine if there is configuration differing from a desired configuration). Second, triggers are defined as described above. Third, inconsistency findings created by the trigger are collected in temporary recommendation nodes and presented on a UI for resolution.

A consistency check can be specified by providing some or all of:

| | |
|---|---|
| ▪ | GBO1: GBO type = “Deployment” |
| | - Definition: Attr1 := GBO1.maz |
| ▪ | GBO2: GBO type = “Deployment” |
| | - Definition: Attr2 := GBO2.maz |
| ▪ | GBR1: GBR type = “binding” |
| | - GBO1 == GBR1.source |
| | - GBO2 == GBR1.target. |

As an example, a more complex, many-hop example would resemble:
(one or many) GBR types defining a path relating these GBOs, including hops over additional GBOs of (one or many) GBO types.

| | |
|---|---|
| - | GBOi: GBO type = “intermediary” |
| - | GBR1: GBR type = “rel1” |
| | ▪ GBO1 == GBR1.source |
| | ▪ GBOi == GBR1.target |
| - | GBR2: GBR type = “rel2” |
| | ▪ GBOi == GBR2.source |
| | ▪ GBO2 == GBR2.target. |

A consistency_check_function, defined by a developer, can include: Result=(attr1==“False” or (attr1==“True” and attr2==“True”)). In natural language description this would be: 1) if this node maz==false, or 2) this node maz==true and any other deployment related using binding having maz==true.

A temporary recommendation node can resemble:

| - | Recommendation GBO type: “Inconsistent Multi AZ statement” | |
|---|---|---|
| | ▪ | Created at: “2022/10/11 13:32:11” |
| | ▪ | Status: “new”. |
| | ▪ | Deletion-condition: status==resolved. |
| | ▪ | GBR type used to relate “Inconsistent Multi AZ statement” to the |
| | | nodes via “identified_inconsistency”. |

Referring to FIG. 11, an example scenario can resemble:

At (1), when attribute MAZ changes, generate an “update trigger” on “GBO1” of type “deployment” (deployment (this) is here the source of the binding) (here, 1102), when attribute MAZ changes:

| | |
|---|---|
| ▪ | Result1 = deployment(this).maz == “False” or |
| ▪ | ( deployment(this).maz == “True” and |
| ▪ | deployment([this == source]).binding(any).deployment(target).maz == “True”) |
| ▪ | Trigger reports consistency violation, if Result1 == “False”. |

At (2), when attribute MAZ changes, generate an “update trigger” on “GBO2” of type “deployment” (deployment (this) is here the target of the binding):

| | |
|---|---|
| ▪ | Result2 = deployment(this).maz == “True” or |
| ▪ | ( deployment(this).maz == “False” and |
| ▪ | deployment([this == target]).binding(any).deployment(source).maz == |
| | ”False”) |
| ▪ | Trigger reports consistency violation, if Result2 == “False”. Note, a consistency violation |
| | will be reported between node 1102 and node 1104. |

At (3), when the GBOs which are related are of type “Deployment”, generate a “create trigger” for a GBR of type “binding”:

| | |
|---|---|
| ▪ | Result3 = binding(this).deployment(source).maz == “False” or |
| ▪ | ( binding(this).deployment(source).maz == “True” and |
| ▪ | binding(this).deployment(target).maz == “True” ) |
| ▪ | Trigger reports consistency violation, if Result3 == “False”. Note the consistency violation |
| | will be reported between node 1102 and node 1104. A “create trigger” is generated for a |
| | GBR of type “binding” (1106). |

In general: create one trigger for each relation and each node in the path. Triggers for nodes are only needed, if an attribute of the nodes needs to be checked or if a relation can be created with either zero or only one node (for example, a dangling relation) and the (other) node(s) is/are created afterwards and later connected to the relation. If such approaches do not exist, triggers for relations are sufficient, as the last “create action” closing the path will be a “create relation.”

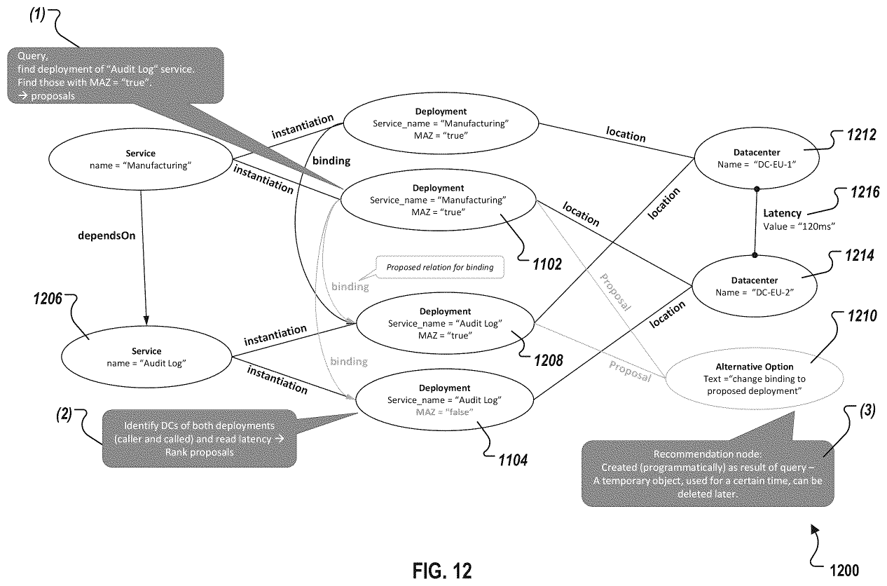

FIG. 12 is a block diagram 300 of a scenario for multi availability zone consistency check creating a temporary recommendation node, according to an implementation of the present disclosure.

The following scenario description related to a landscape graph: recommendation, for example: alternatives to achieve “multi AZ support” in service meshes.

In FIG. 12, and in the same problem space, after finding a constraint violation, the next step can be to find an alternative service deployment, which could make a deployment MAZ=true, instead of merely accepting the lack of Multi AZ functionality and updating the attribute to make the model consistent.

The task is, to find a more suitable deployment, which will enable to set MAZ=true:

At (1), Query: read each node 1102 “deployment” if it has MAZ=“True” and has an outgoing “binding” relation to a node 1104 “deployment” which has MAZ=“False.” This action provides a set of nodes of “problematic deployments,” a recommendation needs to be created for. The deployment node 1104 value “service-type” is read—here “Audit Log”.

At (2), Query: read each node 1206 “service”, identify the nodes of with attribute “name”=“Audit Log”. Then read all related deployments (with relation “instantiation”) (here, 1104 and 1208). Next, select those nodes which have attribute value MAZ=true (here, 1208). The result is a node set of “proposed deployments.”

At (3), for each node N1 in the set of nodes “problematic deployments” (here, 1104): 1) create a TR-node of type “Alternative Option” 1210; 2) relate the node “Alternative Option” 1210 with relation “proposal” to the deployment node N1 (here, 1102); 3) create a relation “proposal” to each node N2 part of set “proposed deployments” (here, 1208); 4) identify the nodes “Datacenter” (here, 1212 and 1214) related using “location” to the deployment nodes; 5) read value of relation “latency” 1216 between the datacenters (here, 120 ms); and 6) compute ranking information of alternative options (smaller latency=higher rank).

In this example, changing the binding to another deployment “Audit Log” could solve the MAZ issue, but then the two services would communicate across different datacenters with an additional latency of 120 ms. An operator can evaluate the proposed alternatives and decide that this alternative is acceptable for the Audit Log service and that enabling Multi AZ capability is more important than the increase in latency and thus accept the proposal.

The following description is related to scenario related to a landscape graph: detecting and reporting deviation from standards.

For software solutions provided to a consumer as a service, the provider typically deploys a set of services with integration configuration (such as, one service calls another). These configurations (that is, the set of services and integrations) are typically specified as “standard,” “blueprint,” or a “template.” However, there can be deviations from these standard configurations. For example, the solution is not yet fully deployed due to a delay in provisioning process; there may be a problem and a service is erroneously terminated or dismantled; or customers can extend the deployment by own services, potentially even replace a service defined by the provider by an own service.

For a provider, it is interesting to know these deviations, either to resolve them since the deviation results in service degradation and cause problems with follow-up operations like updating to a new version of the solution being reflected in a new template (so to say “standard”), or to be informed, that an update of the solution definition to a new extended version may require handling the exception created by the customer.

This can be implemented using a Landscape Graph, where in addition to the landscape of deployed services and their integration configurations, the used standard definitions are stored and can be searched for in the graph. Ideally, upon deployment of a solution, the solution definition and the used templates are stored together with the IT landscape in the graph. For example, a standard can be defined such as: “integration12”, defined as: vendor “service type1”, integrated to vendor “service type2.” A deviation from standard “integration12” can then be identified by finding “services of type1.” If the standard definition is not general but specific to a solution, then only those services are checked which are part of the solution using the standard. A filter needs to be applied (for example, the information if this service has been deployed as part of the solution is a filter criteria). Then the standard integration to “service type2” is checked.

If the “service type1” does not have an integration to “service type2,” a “Deviation Report” node can be created and related to service type1 by a relation of type “identified_deviation.” The node can be amended with the information about the standard being deviated from (“integration12”) and the kind of deviation (“service type2 missing”).

The information that a “Deviation Report” has been created as a temporary recommendation node is forwarded to a responsible administrator. These can then read the data from the “Deviation Report” with immediate navigation options to the impacted services, solution, and, if contained in the graph, the customer information. In this way, deviation analysis can be automated for the administrators and resolving the problem is eased. In addition, the “Deviation Report” can be specified with a “deletion condition,” that it is automatically deleted, if the deviation is resolved and the services are configured according to standard.

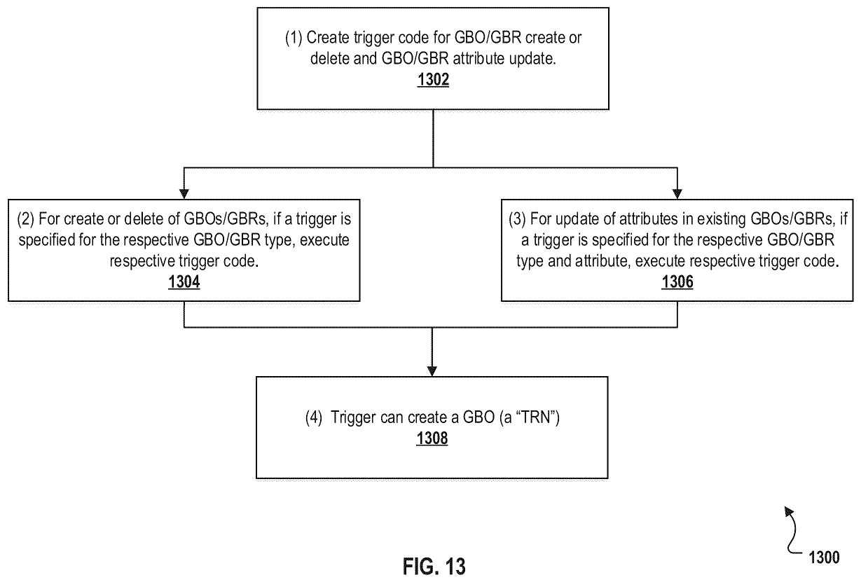

FIG. 13 is a flowchart illustrating an example of a computer-implemented method for providing a landscape graph for information technology operations, according to an implementation of the present disclosure. For clarity of presentation, the description that follows generally describes method 1300 in the context of the other figures in this description. However, it will be understood that method 1300 can be performed, for example, by any system, environment, software, and hardware, or a combination of systems, environments, software, and hardware, as appropriate. In some implementations, various steps of method 1300 can be run in parallel, in combination, in loops, or in any order.

At 1302 (1), trigger code is created by the trigger generator module (part of the GBO factory) for GBO/GBR create or delete action and GBO/GBR update action of GBO/GBR attributes. The trigger generator module can also read consistency check definitions by the active business graph app.

From 1302, using the GBO factory, after replicating changes to an active business graph, method 1300 proceeds to either 1304 or 1306.

At 1304 (2), using the GBO factory, for the GBO/GBR create or delete action, if a trigger is specified for the respective GBO/GBR type, the respective trigger code is executed (“before” or “after” the respective action).

From 1304, method 1300 proceeds to 1308.

At 1306 (3), using the GBO factory, for the GBO/GBR update action of GBO/GBR attributes, if a trigger is specified for the respective GBO/GBR type and attribute, the respective trigger code is executed (“before” or “after” the respective action).

From 1306, method 1300 proceeds to 1308.

At 1308, using the GBO factory, the trigger can create a GBO (a “TRN”) (for example, related to GBO instances being modified during the trigger execution).

After 1308, method 1300 can stop.

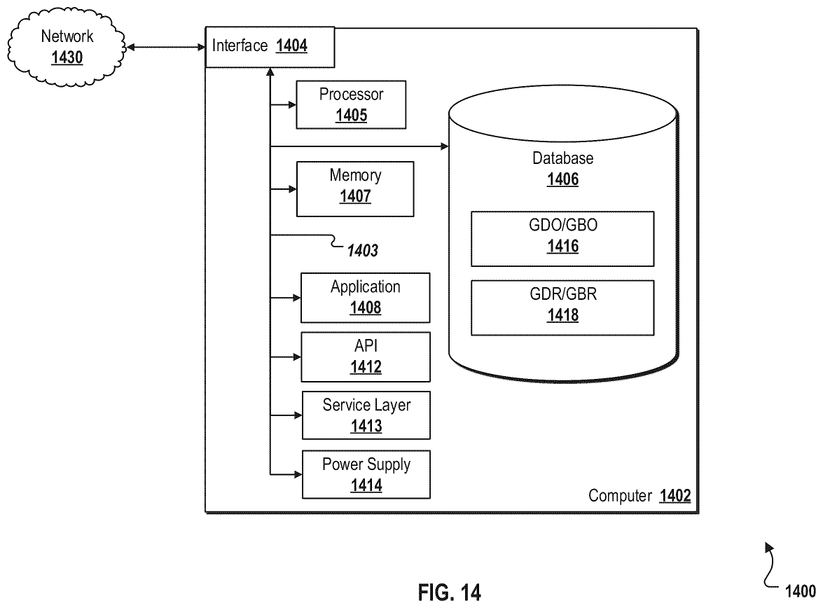

FIG. 14 is a block diagram illustrating an example of a computer-implemented System 1400 used to provide computational functionalities associated with described algorithms, methods, functions, processes, flows, and procedures, according to an implementation of the present disclosure. In the illustrated implementation, System 1400 includes a Computer 1402 and a Network 1430.

The illustrated Computer 1402 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1402 can include an input device, such as a keypad, keyboard, or touch screen, or a combination of input devices that can accept user information, and an output device that conveys information associated with the operation of the Computer 1402, including digital data, visual, audio, another type of information, or a combination of types of information, on a graphical-type user interface (UI) (or GUI) or other UI.

The Computer 1402 can serve in a role in a distributed computing system as, for example, a client, network component, a server, or a database or another persistency, or a combination of roles for performing the subject matter described in the present disclosure. The illustrated Computer 1402 is communicably coupled with a Network 1430. In some implementations, one or more components of the Computer 1402 can be configured to operate within an environment, or a combination of environments, including cloud-computing, local, or global.

At a high level, the Computer 1402 is an electronic computing device operable to receive, transmit, process, store, or manage data and information associated with the described subject matter. According to some implementations, the Computer 1402 can also include or be communicably coupled with a server, such as an application server, e-mail server, web server, caching server, or streaming data server, or a combination of servers.

The Computer 1402 can receive requests over Network 1430 (for example, from a client software application executing on another Computer 1402) and respond to the received requests by processing the received requests using a software application or a combination of software applications. In addition, requests can also be sent to the Computer 1402 from internal users (for example, from a command console or by another internal access method), external or third-parties, or other entities, individuals, systems, or computers.

Each of the components of the Computer 1402 can communicate using a System Bus 1403. In some implementations, any or all of the components of the Computer 1402, including hardware, software, or a combination of hardware and software, can interface over the System Bus 1403 using an application programming interface (API) 1412, a Service Layer 1413, or a combination of the API 1412 and Service Layer 1413. The API 1412 can include specifications for routines, data structures, and object classes. The API 1412 can be either computer-language independent or dependent and refer to a complete interface, a single function, or even a set of APIs. The Service Layer 1413 provides software services to the Computer 1402 or other components (whether illustrated or not) that are communicably coupled to the Computer 1402. The functionality of the Computer 1402 can be accessible for all service consumers using the Service Layer 1413. Software services, such as those provided by the Service Layer 1413, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1402, alternative implementations can illustrate the API 1412 or the Service Layer 1413 as stand-alone components in relation to other components of the Computer 1402 or other components (whether illustrated or not) that are communicably coupled to the Computer 1402. Moreover, any or all parts of the API 1412 or the Service Layer 1413 can be implemented as a child or a sub-module of another software module, enterprise application, or hardware module without departing from the scope of the present disclosure.

The Computer 1402 includes an Interface 1404. Although illustrated as a single Interface 1404, two or more Interfaces 1404 can be used according to particular needs, desires, or particular implementations of the Computer 1402. The Interface 1404 is used by the Computer 1402 for communicating with another computing system (whether illustrated or not) that is communicatively linked to the Network 1430 in a distributed environment. Generally, the Interface 1404 is operable to communicate with the Network 1430 and includes logic encoded in software, hardware, or a combination of software and hardware. More specifically, the Interface 1404 can include software supporting one or more communication protocols associated with communications such that the Network 1430 or hardware of Interface 1404 is operable to communicate physical signals within and outside of the illustrated Computer 1402.

The Computer 1402 includes a Processor 1405. Although illustrated as a single Processor 1405, two or more Processors 1405 can be used according to particular needs, desires, or particular implementations of the Computer 1402. Generally, the Processor 1405 executes instructions and manipulates data to perform the operations of the Computer 1402 and any algorithms, methods, functions, processes, flows, and procedures as described in the present disclosure.

The Computer 1402 also includes a Database 1406 that can hold data for the Computer 1402, another component communicatively linked to the Network 1430 (whether illustrated or not), or a combination of the Computer 1402 and another component. For example, Database 1406 can be an in-memory or conventional database storing data consistent with the present disclosure. In some implementations, Database 1406 can be a combination of two or more different database types (for example, a hybrid in-memory and conventional database) according to particular needs, desires, or particular implementations of the Computer 1402 and the described functionality. Although illustrated as a single Database 1406, two or more databases of similar or differing types can be used according to particular needs, desires, or particular implementations of the Computer 1402 and the described functionality. While Database 1406 is illustrated as an integral component of the Computer 1402, in alternative implementations, Database 1406 can be external to the Computer 1402. As illustrated, the Database 1406 holds the previously described GDOs/GBOs 1416 and GDRs/GBRs 1418.

The Computer 1402 also includes a Memory 1407 that can hold data for the Computer 1402, another component or components communicatively linked to the Network 1430 (whether illustrated or not), or a combination of the Computer 1402 and another component. Memory 1407 can store any data consistent with the present disclosure. In some implementations, Memory 1407 can be a combination of two or more different types of memory (for example, a combination of semiconductor and magnetic storage) according to particular needs, desires, or particular implementations of the Computer 1402 and the described functionality. Although illustrated as a single Memory 1407, two or more Memories 1407 or similar or differing types can be used according to particular needs, desires, or particular implementations of the Computer 1402 and the described functionality. While Memory 1407 is illustrated as an integral component of the Computer 1402, in alternative implementations, Memory 1407 can be external to the Computer 1402.

The Application 1408 is an algorithmic software engine providing functionality according to particular needs, desires, or particular implementations of the Computer 1402, particularly with respect to functionality described in the present disclosure. For example, Application 1408 can serve as one or more components, modules, or applications. Further, although illustrated as a single Application 1408, the Application 1408 can be implemented as multiple Applications 1408 on the Computer 1402. In addition, although illustrated as integral to the Computer 1402, in alternative implementations, the Application 1408 can be external to the Computer 1402.

The Computer 1402 can also include a Power Supply 1414. The Power Supply 1414 can include a rechargeable or non-rechargeable battery that can be configured to be either user- or non-user-replaceable. In some implementations, the Power Supply 1414 can include power-conversion or management circuits (including recharging, standby, or another power management functionality). In some implementations, the Power Supply 1414 can include a power plug to allow the Computer 1402 to be plugged into a wall socket or another power source to, for example, power the Computer 1402 or recharge a rechargeable battery.

There can be any number of Computers 1402 associated with, or external to, a computer system containing Computer 1402, each Computer 1402 communicating over Network 1430. Further, the term “client,” “user,” or other appropriate terminology can be used interchangeably, as appropriate, without departing from the scope of the present disclosure. Moreover, the present disclosure contemplates that many users can use one Computer 1402, or that one user can use multiple computers 1402.

Described implementations of the subject matter can include one or more features, alone or in combination.

For example, in a first implementation, a computer-implemented method, comprising: creating, by a trigger generator module of a graph business object (GBO) factory, trigger code; using the GBO factory, after replicating changes to an active business graph: for a GBO/graph business relation (GBR) create or delete action, executing trigger code of a specified trigger for a respective GBO/GBR type; or for a GBO/GBR update action of GBO/GBR attributes, executing trigger code of a specified trigger for a respective GBO/GBR type and attribute; and creating, with the trigger code and using the GBO factory, a temporary recommendation node (TRN).

The foregoing and other described implementations can each, optionally, include one or more of the following features:

A first feature, combinable with any of the following features, wherein the trigger code is created for the GBO/GBR create or delete action and the GBO/GBR update action.

A second feature, combinable with any of the previous or following features, wherein the trigger code is executed before or after the respective action.

A third feature, combinable with any of the previous or following features, wherein the TRN is related to a GBO/GBR created, deleted, or updated during execution of the trigger code.

A fourth feature, combinable with any of the previous or following features, comprising reading, by the trigger generator module, consistency check definitions by an active business graph application.

A fifth feature, combinable with any of the previous or following features, wherein the active business graph application is configured to execute application code to operate on an active business graph by read operations executing path traversal, path analytics, and other read-path algorithms.

A sixth feature, combinable with any of the previous or following features, wherein the TRN is a variant of a GBO and comprises additional attributes, including one or more of: 1) type temporary; 2) created at; 3) status; 4) retention time; 5) archiving; and developer-defined attributes.

In a second implementation, a non-transitory, computer-readable medium storing one or more instructions executable by a computer system to perform operations, comprising: creating, by a trigger generator module of a graph business object (GBO) factory, trigger code; using the GBO factory, after replicating changes to an active business graph: for a GBO/graph business relation (GBR) create or delete action, executing trigger code of a specified trigger for a respective GBO/GBR type; or for a GBO/GBR update action of GBO/GBR attributes, executing trigger code of a specified trigger for a respective GBO/GBR type and attribute; and creating, with the trigger code and using the GBO factory, a temporary recommendation node (TRN).

The foregoing and other described implementations can each, optionally, include one or more of the following features:

A first feature, combinable with any of the following features, wherein the trigger code is created for the GBO/GBR create or delete action and the GBO/GBR update action.

A second feature, combinable with any of the previous or following features, wherein the trigger code is executed before or after the respective action.

A third feature, combinable with any of the previous or following features, wherein the TRN is related to a GBO/GBR created, deleted, or updated during execution of the trigger code.

A fourth feature, combinable with any of the previous or following features, comprising reading, by the trigger generator module, consistency check definitions by an active business graph application.

A fifth feature, combinable with any of the previous or following features, wherein the active business graph application is configured to execute application code to operate on an active business graph by read operations executing path traversal, path analytics, and other read-path algorithms.

A sixth feature, combinable with any of the previous or following features, wherein the TRN is a variant of a GBO and comprises additional attributes, including one or more of: 1) type temporary; 2) created at; 3) status; 4) retention time; 5) archiving; and developer-defined attributes.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: creating, by a trigger generator module of a graph business object (GBO) factory, trigger code; using the GBO factory, after replicating changes to an active business graph: for a GBO/graph business relation (GBR) create or delete action, executing trigger code of a specified trigger for a respective GBO/GBR type; or for a GBO/GBR update action of GBO/GBR attributes, executing trigger code of a specified trigger for a respective GBO/GBR type and attribute; and creating, with the trigger code and using the GBO factory, a temporary recommendation node (TRN).

The foregoing and other described implementations can each, optionally, include one or more of the following features:

A first feature, combinable with any of the following features, wherein the trigger code is created for the GBO/GBR create or delete action and the GBO/GBR update action.

A second feature, combinable with any of the previous or following features, wherein the trigger code is executed before or after the respective action.

A third feature, combinable with any of the previous or following features, wherein the TRN is related to a GBO/GBR created, deleted, or updated during execution of the trigger code.

A fourth feature, combinable with any of the previous or following features, comprising reading, by the trigger generator module, consistency check definitions by an active business graph application.

A fifth feature, combinable with any of the previous or following features, wherein the active business graph application is configured to execute application code to operate on an active business graph by read operations executing path traversal, path analytics, and other read-path algorithms.

A sixth feature, combinable with any of the previous or following features, wherein the TRN is a variant of a GBO and comprises additional attributes, including one or more of: 1) type temporary; 2) created at; 3) status; 4) retention time; 5) archiving; and developer-defined attributes.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
creating, by a trigger generator module of a graph business object (GBO) factory, trigger code;
using the GBO factory, after replicating changes to an active business graph:
for a GBO/graph business relation (GBR) create or delete action, executing trigger code of a specified trigger for a respective GBO/GBR type; or
for a GBO/GBR update action of GBO/GBR attributes, executing trigger code of a specified trigger for a respective GBO/GBR type and attribute; and
creating, with the trigger code and using the GBO factory, a temporary recommendation node (TRN).

2. The computer-implemented method of claim 1, wherein the trigger code is created for the GBO/GBR create or delete action and the GBO/GBR update action.

3. The computer-implemented method of claim 2, wherein the trigger code is executed before or after the respective action.

4. The computer-implemented method of claim 3, wherein the TRN is related to a GBO/GBR created, deleted, or updated during execution of the trigger code.

5. The computer-implemented method of claim 1, comprising reading, by the trigger generator module, consistency check definitions by an active business graph application.

6. The computer-implemented method of claim 5, wherein the active business graph application is configured to execute application code to operate on an active business graph by read operations executing path traversal, path analytics, and other read-path algorithms.

7. The computer-implemented method of claim 1, wherein the TRN is a variant of a GBO and comprises additional attributes, including one or more of: 1) type temporary; 2) created at; 3) status; 4) retention time; 5) archiving; and developer-defined attributes.

8. A non-transitory, computer-readable medium storing one or more instructions executable by a computer system to perform operations, comprising:
creating, by a trigger generator module of a graph business object (GBO) factory, trigger code;
using the GBO factory, after replicating changes to an active business graph:
for a GBO/graph business relation (GBR) create or delete action, executing trigger code of a specified trigger for a respective GBO/GBR type; or
for a GBO/GBR update action of GBO/GBR attributes, executing trigger code of a specified trigger for a respective GBO/GBR type and attribute; and
creating, with the trigger code and using the GBO factory, a temporary recommendation node (TRN).

9. The non-transitory, computer-readable medium of claim 8, wherein the trigger code is created for the GBO/GBR create or delete action and the GBO/GBR update action.

10. The non-transitory, computer-readable medium of claim 9, wherein the trigger code is executed before or after the respective action.

11. The non-transitory, computer-readable medium of claim 10, wherein the TRN is related to a GBO/GBR created, deleted, or updated during execution of the trigger code.

12. The non-transitory, computer-readable medium of claim 8, comprising reading, by the trigger generator module, consistency check definitions by an active business graph application.

13. The non-transitory, computer-readable medium of claim 12, wherein the active business graph application is configured to execute application code to operate on an active business graph by read operations executing path traversal, path analytics, and other read-path algorithms.

14. The non-transitory, computer-readable medium of claim 8, wherein the TRN is a variant of a GBO and comprises additional attributes, including one or more of: 1) type temporary; 2) created at; 3) status; 4) retention time; 5) archiving; and developer-defined attributes.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
creating, by a trigger generator module of a graph business object (GBO) factory, trigger code;
using the GBO factory, after replicating changes to an active business graph:
for a GBO/graph business relation (GBR) create or delete action, executing trigger code of a specified trigger for a respective GBO/GBR type; or
for a GBO/GBR update action of GBO/GBR attributes, executing trigger code of a specified trigger for a respective GBO/GBR type and attribute; and
creating, with the trigger code and using the GBO factory, a temporary recommendation node (TRN).

16. The computer-implemented system of claim 15, wherein the trigger code is created for the GBO/GBR create or delete action and the GBO/GBR update action.

17. The computer-implemented system of claim 16, wherein the trigger code is executed before or after the respective action.

18. The computer-implemented system of claim 17, wherein the TRN is related to a GBO/GBR created, deleted, or updated during execution of the trigger code.

19. The computer-implemented system of claim 15, comprising reading, by the trigger generator module, consistency check definitions by an active business graph application.

20. The computer-implemented system of claim 19, wherein the active business graph application is configured to execute application code to operate on an active business graph by read operations executing path traversal, path analytics, and other read-path algorithms.

21. The computer-implemented system of claim 15, wherein the TRN is a variant of a GBO and comprises additional attributes, including one or more of: 1) type temporary; 2) created at; 3) status; 4) retention time; 5) archiving; and developer-defined attributes.
